(19) United States
(12) Patent Application Publication
(10) Pub. No.: US 2014/0361642 A1
(43) Pub. Date: Dec. 11, 2014

(54) MICROCURRENT GENERATION DEVICE

(71) Applicant: Woo Seung Seo, Seoul (KR)

(72) Inventor: Woo Seung Seo, Seoul (KR)

(73) Assignee: JIONE FRS CORPORATION, Seoul (KR)

(21) Appl. No.: 14/369,530

(22) PCT Filed: Dec. 27, 2012
(86) PCT No.: PCT/KR2012/011623

§ 371 Date: Jun. 27, 2014

(30) Foreign Application Priority Data
Dec. 27, 2011 (KR) 10-2011-0143153

(51) Int. Cl. H02K 1/34

(52) U.S. Cl. CPC H02K 1/34
USPC 310/36

(57) ABSTRACT

Disclosed is a device for generating micro electrical current capable of enhancing micro electrical current generation efficiency. The device for generating micro electrical current includes a housing having an accommodation space therein, a coil block accommodated inside the housing, a movable magnet movably provided at one surface of the coil block to generate a micro electrical current through interaction with the coil block, and an elastic member for elastically supporting movement of the movable magnet with respect to the coil block. After a first motion of the movable magnet with respect to the coil block, the movable magnet vibrates by the elastic member and interacts with the coil block.

### TECHNICAL FIELD

The present invention relates to a device for generating micro electrical current, and more particularly to a device for generating micro electrical current capable of improving an efficiency of generating a micro electrical current.

### BACKGROUND ART

In general, a micro electrical current (weak current) called a bioelectric current flows in a human body. Such bioelectric current enables the cerebrum and the internal organs to exchange information with each other to maintain health. If a person is in poor health, the bioelectric current becomes weak and unstable. It is known that the micro electrical current can promote blood circulation and smooth metabolism and eventually can enhance natural healing properties.

It is also known that the proper micro electrical current is effective in regenerating cells, relieving pain, improving blood circulation, promoting secretion of hormones and so on. The cases of using the micro electrical current for medical treatment or massage are on an increasing trend.

Accordingly, many researches and developments in the field of a device for generating micro electrical current have been actively made.

There is disclosed a conventional device for generating micro electrical current which converts electricity supplied from a battery into a micro electrical current. However, this conventional device for generating micro electrical current has drawbacks in that maintenance costs are relatively high because of frequent replacement of the battery and practicability and productivity are low because a space for installation of the battery is necessary and watertightness for protecting electronic components should be ensured.

There is also disclosed a conventional device for generating micro electrical current including a piezoelectric device capable of generating a micro electrical current through pressure applied thereto. However, manufacturing costs are high due to a relatively expensive piezoelectric device. Further, since external force should be exerted to generate a micro electrical current, the installation location is very limited.

According to another conventional device for generating micro electrical current, the structure thereof is simple such that a micro electrical current is generated by movement of a magnet with respect to a coil. However, without any action (or external force) around the device, the movement of the magnet is stopped and thus a micro electrical current is not generated. As such, only when external force is applied or action occurs around the device, the magnet is moved and a micro electrical current is generated. Therefore, it is hard to obtain successive generation of a micro electrical current, that is, a micro electrical current is generated intermittently.

Thus, it is demanded to develop a device for generating micro electrical current which has a simple structure, gives reduced manufacturing costs and maintenance costs and enhances micro electrical current generation efficiency.

### DISCLOSURE

### Technical Problem

Therefore, it is an object of the present invention to provide a device for generating micro electrical current capable of enhancing micro electrical current generation efficiency and generating a micro electrical current semi-permanently.

It is another object of the present invention to provide a device for generating micro electrical current capable of simplifying a structure and reducing manufacturing costs and maintenance costs.

It is a further object of the present invention to provide a device for generating micro electrical current capable of being installed at various locations without limitation.

### Technical Solution

In accordance with an aspect of the present invention, the above and other objects can be accomplished by the provision of a device for generating micro electrical current comprising a housing having an accommodation space therein, a coil block accommodated inside the housing, a movable magnet movably provided at one surface of the coil block to generate a micro electrical current through interaction with the coil block, and an elastic member for elastically supporting movement of the movable magnet with respect to the coil block, wherein after a first motion of the movable magnet with respect to the coil block, the movable magnet vibrates by the elastic member and interacts with the coil block.

The coil block may be formed by winding a common coil, and may be formed in various shapes according to required conditions and design specifications. For example, the coil block may be formed in a substantially circular disc shape.

The movable magnet may be movably provided at one surface of the coil block and may generate a micro electrical current through interaction with the coil block. For example, the movable magnet may be arranged on the coil block to be movable horizontally. According to circumstances, the movable magnet may be arranged beneath the coil block, or two movable magnets may be respectively arranged on and beneath the coil block.

For reference, the micro electrical current in the present invention may be a current which is in the range from a few microamperes (μA) to hundreds of microamperes (μA), and may be generally referred to as sub-sensory level stimulation. Since the intensity of current in the stimulation by the micro electrical current is much lower than that in transcutaneous electrical nerve stimulation, the stimulation by the micro electrical current may be discriminated from other types of electrical stimulation. Preferably, a micro electrical current ranging from about 10 to about 1000 μA may be generated by interaction due to movement of the movable magnet with respect to the coil block.

As the elastic member, a common elastic member may be employed as long as it can elastically support movement of the movable magnet, and the present invention is not limited or restricted by the kind and characteristics of the elastic member.

By virtue of the elastic member elastically supporting movement of the movable magnet, after a first motion of the movable magnet with respect to the coil block, the movable magnet may vibrate by elastic force of the elastic member and thus may interact with the coil block. Herein, the first motion of the movable magnet may include not only the moment when the movable magnet moves for the first time with respect to the coil block by external pressure or action around the device from the state in which the movement of the movable magnet is stopped, but also the moment when the movable magnet starts new movement again by different pressure or action around the device from the state in which the movement of the movable magnet is not yet stopped.

For example, the elastic member may be formed as a plate spring type which includes a fixing portion fixed to the housing, a bent elastic portion extending integrally from an end of the fixing portion, and a support portion extending integrally from an end of the bent elastic portion and supporting the movable magnet. The movable magnet may be elastically supported by the elastic member which works as a cantilever. According to circumstances, other various types of springs, such as a coil spring, may be employed as the elastic member. Alternatively, it may be constituted such that the movable magnet is supported simultaneously by plural elastic members.

The bent elastic portion may be formed in various shapes according to required conditions and design specifications. For example, the bent elastic portion may be bent in a zigzag shape. The shape and characteristics of the bent elastic portion may be adequately changed according to required conditions and design specifications.

The support portion may be configured to support the movable magnet in various ways according to required conditions and design specifications. For example, the support portion may be formed to have a smaller size than a diameter of the movable magnet and to elastically surround an outer surface of the movable magnet.

The device for generating micro electrical current may include a coupling member so as to be installed to an object. The housing may be accommodated inside the coupling member. The coupling member may be coupled to an object by a common coupling or adhering method. The present invention is not limited or restricted by the coupling method between the coupling member and an object.

The coupling member may be provided with a stimulation member which is electrically connected to the coil block and arranged to contact a human body. For example, the stimulation member may be formed in a protrusion shape and installed on the coupling member. According to circumstances, the stimulation member may be formed in a sheet shape of a conductive material and arranged apart from the coil block (or the coupling member).

For reference, the object in the present invention at which the device for generating micro electrical current is installed may include common clothes, caps, bags, accessories and the like which come into contact with a human body. The present invention is not limited or restricted by the kind and characteristics of the object. For example, the device for generating micro electrical current according to the present invention may be installed on an upper end portion of a tongue of a common shoe. According to circumstances, the device for generating micro electrical current may also be installed on an upper or other different portions of a shoe.

### Advantageous Effects

According to the device for generating micro electrical current of the present invention, generation efficiency of a micro electrical current can be enhanced.

Specifically, since the movable magnet vibrates by the elastic member and also interlocks with the coil block after the first motion of the movable magnet with respect to the coil block, micro electrical current generation efficiency can be enhanced. That is, since the movable magnet is elastically supported by the elastic member, even though additional external force or action is not exerted on the movable magnet after the first motion of the movable magnet, the movable magnet can vibrate and interact with the coil block. Accordingly, additional micro electrical current generation can be realized.

As such, according to the present invention, since the movable magnet can vibrate after the first motion thereof, successive generation of a micro electrical current can be achieved. For example, the movable magnet can vibrate from the moment of the first motion thereof caused by user's walking action until the next action occurs. Accordingly, a micro electrical current can be successively generated during the walking action.

Further, according to the present invention, a micro electrical current can be generated semi-permanently without using an additional battery or expensive piezoelectric device. Therefore, the structure can be simplified, and manufacturing costs and maintenance costs can be reduced.

In addition, according to the present invention, since the movable magnet can be moved and a micro electrical current can be generated even by a minute action around the device, the device for generating micro electrical current can be installed at various locations and on various objects without limitation.

Further, by using a micro electrical current generated by the movement of the movable magnet with respect to the coil block, the device for generating micro electrical current according to the present invention is effective in delaying secretion of lactic acid (fatigue-inducing substance), relieving pain, improving blood circulation, promoting secretion of hormones and so on.

### DESCRIPTION OF DRAWINGS

The above and other objects, features and other advantages of the present invention will be more clearly understood from the following detailed description taken in conjunction with the accompanying drawings, in which:

FIG. 1 is a perspective view illustrating a structure of a device for generating micro electrical current according to an exemplary embodiment of the present invention;

FIG. 2 is a plan view illustrating a structure of a device for generating micro electrical current according to an exemplary embodiment of the present invention;

FIG. 3 is a cross-sectional view illustrating a structure of a device for generating micro electrical current according to an exemplary embodiment of the present invention;

FIG. 4 is a view to explain an operational principle of a device for generating micro electrical current according to an exemplary embodiment of the present invention;

FIG. 5 is a view to explain an installation example of a device for generating micro electrical current according to an exemplary embodiment of the present invention;

FIG. 6 is a view to explain another installation example of a device for generating micro electrical current according to an exemplary embodiment of the present invention; and

FIG. 7 is a view illustrating a device for generating micro electrical current according to another exemplary embodiment of the present invention.

### BEST MODE

Now, preferred embodiments of the present invention will be described in detail with reference to the accompanying drawings. The preferred embodiments described in the specification and shown in the drawings are illustrative only and are not intended to represent all aspects of the invention. Throughout the specification, the same reference numerals represent the same components. Further, the same or similar components are denoted by the same reference numerals even though they are depicted in different drawings. A detailed description of known functions and configurations incorporated herein will be omitted.

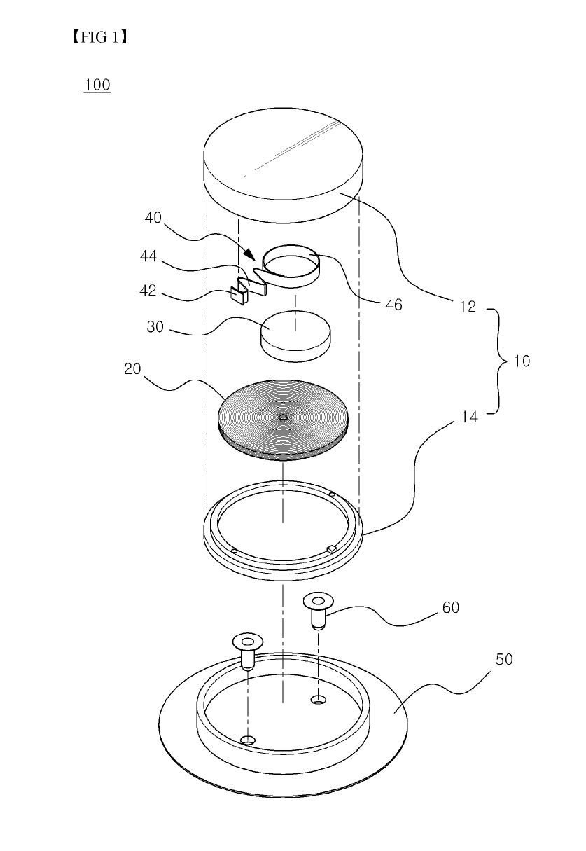

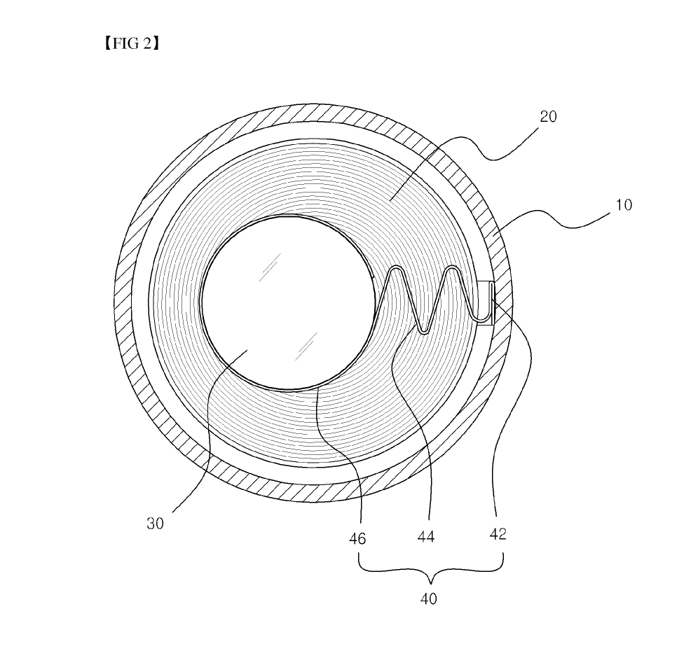

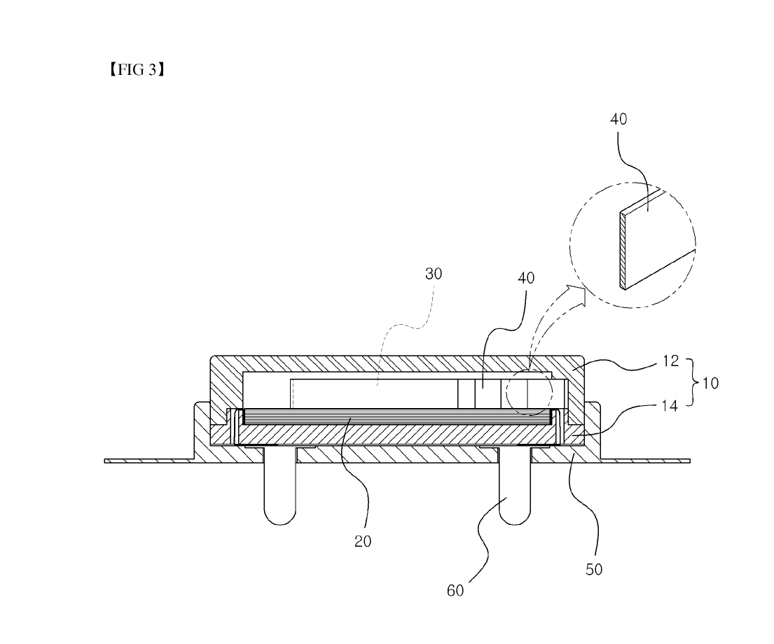

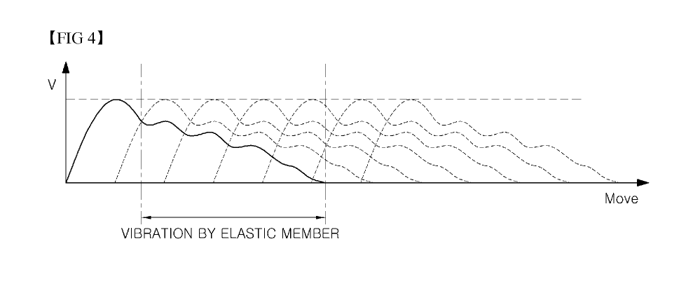

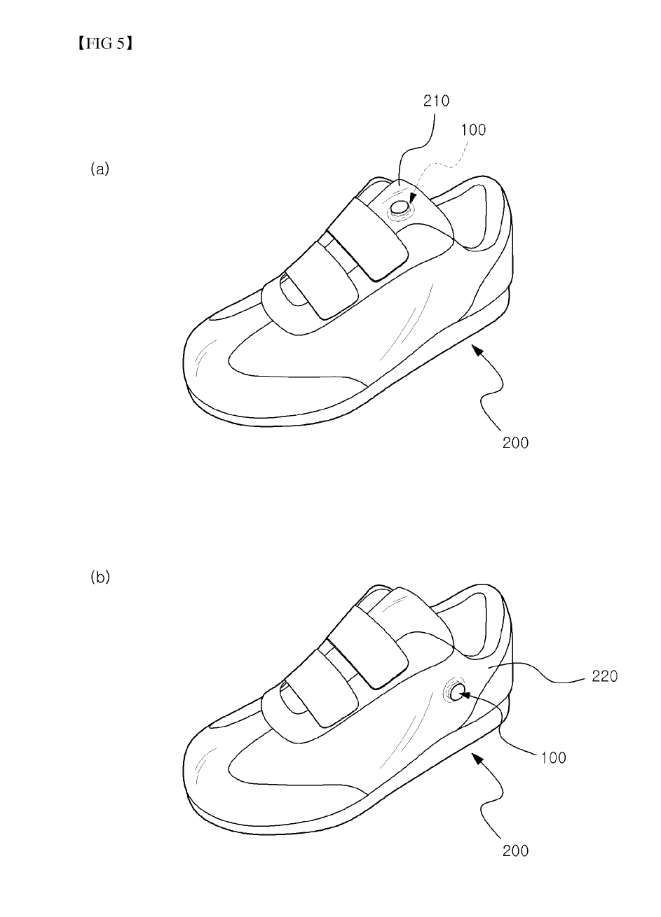

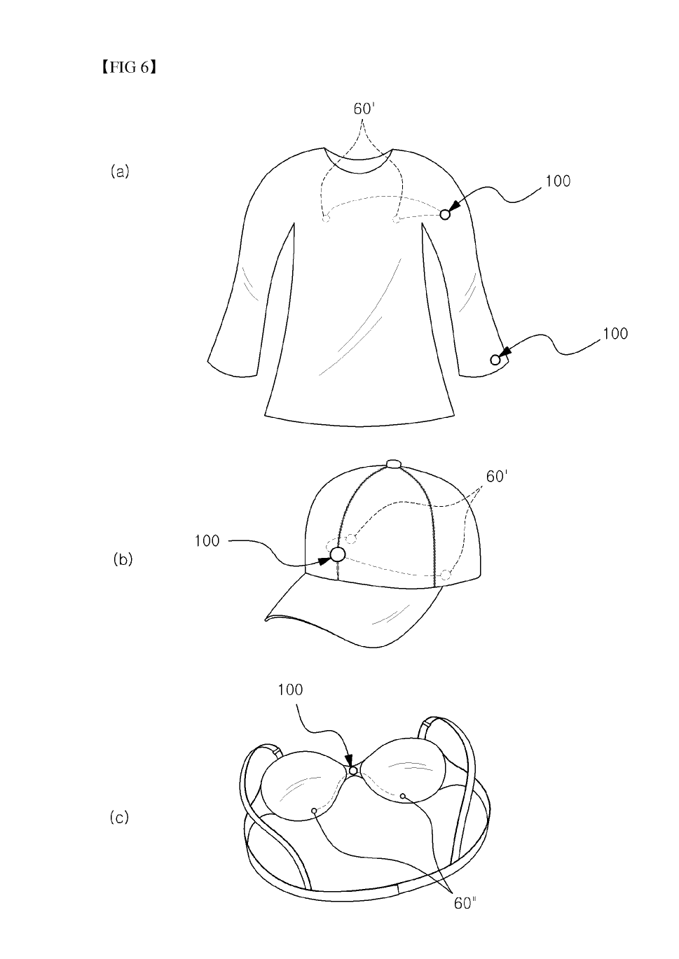

FIG. 1 is a perspective view illustrating a structure of a device for generating micro electrical current according to an exemplary embodiment of the present invention, FIG. 2 is a plan view illustrating a structure of a device for generating micro electrical current according to an exemplary embodiment of the present invention, and FIG. 3 is a cross-sectional view illustrating a structure of a device for generating micro electrical current according to an exemplary embodiment of the present invention. FIG. 4 is a view to explain an operational principle of a device for generating micro electrical current according to an exemplary embodiment of the present invention, FIG. 5 is a view to explain an installation example of a device for generating micro electrical current according to an exemplary embodiment of the present invention, and FIG. 6 is a view to explain another installation example of a device for generating micro electrical current according to an exemplary embodiment of the present invention.

Referring to FIGS. 1 through 3, a device for generating micro electrical current 100 according to the present invention comprises a housing 10, a coil block 20, a movable magnet 30, and an elastic member 40.

The housing 10 includes an accommodation space therein, and may have various shapes according to required conditions and design specifications. For example, the housing 10 may be formed in a substantially cylindrical shape which includes an upper housing 12 and a lower housing 14 to cooperatively define an inner space thereinside.

The coil block 20 is accommodated inside the lower housing 14, and can generate a micro electrical current through interaction with the movable magnet 30 which will be described later. The coil block 20 may be formed by winding a common coil. Hereinafter, the embodiment will be explained with reference to the coil block 20 which is formed in a substantially circular disc shape. According to circumstances, the coil block may be formed in other various shapes.

The movable magnet 30 is movably provided at one surface of the coil block 20 and can generate a micro electrical current through interaction with the coil block 20. Hereinafter, the embodiment will be explained with reference to the movable magnet 30 which is arranged on the coil block 20 to be movable horizontally. According to circumstances, the movable magnet may be arranged beneath the coil block, or two movable magnets may be respectively arranged on and beneath the coil block.

As the movable magnet 30, a common magnet may be employed. The movable magnet 30 can move with respect to the coil block 20 by external pressure or action around the device. As the movable magnet 30 moves with respect to the coil block 20, an induced current (micro electrical current) and a magnetic field can be generated at the coil block 20.

For reference, the micro electrical current in the present invention is a current which is in the range from a few microamperes (μA) to hundreds of microamperes (μA), and can be generally referred to as sub-sensory level stimulation. Since the intensity of current in the stimulation by the micro electrical current is much lower than that in transcutaneous electrical nerve stimulation, the stimulation by the micro electrical current can be discriminated from other types of electrical stimulation. Preferably, a micro electrical current ranging from about 10 to about 1000 μA can be generated by interaction due to movement of the movable magnet 30 with respect to the coil block 20.

The elastic member 40 is configured to elastically support movement of the movable magnet 30 with respect to the coil block 20. As the elastic member 40, a common elastic member may be employed as long as it can elastically support movement of the movable magnet 30. The present invention is not limited or restricted by the kind and characteristics of the elastic member 40.

By virtue of the elastic member 40 elastically supporting movement of the movable magnet 30, after a first motion of the movable magnet 30 with respect to the coil block 20, the movable magnet 30 vibrates by elastic force of the elastic member 40 caused by the first motion of the movable magnet 30, and thereby interacts with the coil block 20.

Herein, the first motion of the movable magnet 30 includes not only the moment when the movable magnet 30 moves for the first time with respect to the coil block 20 by external pressure or action around the device from the state in which the movement of the movable magnet 30 is stopped, but also the moment when the movable magnet 30 starts new movement again by different pressure or action around the device from the state in which the movement of the movable magnet 30 is not yet stopped. At the first motion of the movable magnet 30, the elastic member 40 may be elastically deformed. After the first motion of the movable magnet 30 is completed, the movable magnet 30 may vibrate by restoring force and damping force of the elastic member 40.

Hereinafter, the embodiment of the present invention will be explained with reference to the elastic member 40 which is formed as a plate spring type having long sides in cross section which are arranged vertically to the one surface of the coil block so as to maximize the horizontal vibration of the movable magnet 30. For example, the elastic member 40 includes a fixing portion 42 fixed to the upper housing 12, a bent elastic portion 44 extending integrally from an end of the fixing portion 42, and a support portion 46 extending integrally from an end of the bent elastic portion 44 and supporting the movable magnet 30. The movable magnet 30 can be elastically supported by the elastic member 40 in a cantilever type. According to circumstances, other various types of springs, such as a coil spring, may be employed as the elastic member.

The upper housing 12 may be formed with a fixing recess to which the end of the fixing portion 42 is fixed. According to circumstances, the fixing portion may be fixed to the upper housing using an additional fastening or bonding means.

The bent elastic portion 44 may be formed in various shapes according to required conditions and design specifications. For example, the bent elastic portion 44 may be bent in a zigzag shape. It may also be possible to form the bent elastic portion in a straight line shape, however, the bent elastic portion is preferably formed in a zigzag shape so as to maximize the vibration due to the first motion of the movable magnet. According to circumstances, the bent elastic portion may be formed in an L shape or other various shapes, however, the present invention is not limited or restricted by the shape and bent characteristics of the bent elastic portion.

The support portion 46 may be configured to support the movable magnet 30 in various ways according to required conditions and design specifications. For example, the support portion 46 may be formed to have a smaller size than a diameter of the movable magnet 30 and to elastically surround an outer circumferential surface of the movable magnet 30. Such a structure allows the movable magnet 30 to be supported by the support portion 46 without an additional fastening or bonding means. However, according to circumstances, it may be constituted such that the movable magnet is supported by the support portion using an additional fastening or bonding means.

As described above, since the movable magnet 30 is elastically supported and vibrates by means of the elastic member 40, micro electrical current generation efficiency can be more enhanced. In the case without the additional elastic member 40, since the movable magnet 30 is only moved when external force is applied or action occurs around the device, it is hard to obtain successive generation of a micro electrical current, that is, a micro electrical current is generated intermittently. However, according to the present invention, since the movable magnet 30 can vibrate by the elastic member 40 after the first motion of the movable magnet 30, a micro electrical current can be successively generated. In other words, referring to FIG. 4, even though additional external force or action is not exerted on the movable magnet 30 after the first motion of the movable magnet 30, the movable magnet 30 vibrates by means of the elastic member 40 and also interacts with the coil block 20. Accordingly, additional micro electrical current generation can be realized, and thereby a micro electrical current can be successively generated.

The device for generating micro electrical current 100 according to the present invention may include a coupling member 50 so as to be installed to an object. The housing 10 may be accommodated inside the coupling member 50, and may be installed to an object by means of the coupling member 50. The coupling member 50 may be coupled to an object by a common coupling or adhering method. The present invention is not limited or restricted by the coupling method between the coupling member 50 and an object.

The coupling member 50 may be provided with a stimulation member 60 which is electrically connected to the coil block 20 and exposed to the outside to contact a human body. The micro electrical current generated by interaction between the coil block 20 and the movable magnet 30 can stimulate a human body through the stimulation member 60.

For reference, although it is described in the embodiment of the present invention that the stimulation member is formed in a protrusion shape and installed on the coupling member, the stimulation member may be formed in a sheet shape of a conductive material and arranged apart from the coil block (or the coupling member) according to circumstances.

Since the device for generating micro electrical current 100 according to the present invention can be operated even by a minute movement around the device, i.e., the movable magnet 30 can be moved and a micro electrical current can be generated even by a minute movement around the device, the device can be installed at various locations and on various objects without limitation.

For reference, the object in the present invention at which the device for generating micro electrical current 100 is installed may include common clothes, caps, bags, accessories and the like which come into contact with a human body. The present invention is not limited or restricted by the kind and characteristics of the object.

For example, referring to FIG. 5, the device for generating micro electrical current 100 according to the present invention may be installed on an upper end portion of a tongue 210 or a side portion of an upper of a common shoe 200. According to circumstances, the device for generating micro electrical current may also be installed on other different portions of the shoe.

For other examples, referring to FIG. 6, the device for generating micro electrical current 100 according to the present invention may be installed on clothes, a cap and a brassiere. According to required conditions, one or more device for generating micro electrical currents may be installed on the object. The micro electrical current generated from the device for generating micro electrical current 100 can stimulate a human body through a stimulation member 60′. The arrangement position of the stimulation member 60′ may be adequately changed according to the kind and characteristics of the object. For example, in the case in which the device for generating micro electrical current 100 is installed on clothes, the stimulation member 60′ may be arranged near a heart. In the case in which the device for generating micro electrical current 100 is installed on a cap, the stimulation member 60′ may be arranged near temples. In the case in which the device for generating micro electrical current 100 is installed on a brassiere, the stimulation member 60″ may be arranged at breasts.

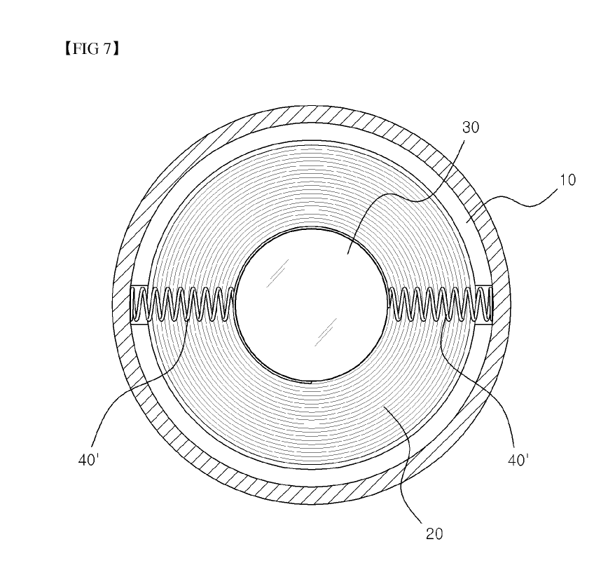

FIG. 7 is a view illustrating a device for generating micro electrical current according to another exemplary embodiment of the present invention. The same or similar components as those of the previous embodiment are denoted by the same reference numerals, and detailed explanation thereof will be omitted.

The previous embodiment according to the present invention described above is constituted such that the movable magnet is supported by the single elastic member in a cantilever type. However, according to circumstances, it may be constituted such that the movable magnet is supported simultaneously by plural elastic members.

Referring to FIG. 7, the device for generating micro electrical current may comprise a housing 10, a coil block 20, a movable magnet 30, and plural elastic members 40′ for elastically supporting the movable magnet 30. For example, it may be constituted such that the movable magnet 30 is supported simultaneously by two elastic members 40′ which are formed as a coil spring type. According to circumstances, three or more elastic members may be used, and the present invention is not limited or restricted by the number or arrangement interval of the elastic members. Meanwhile, the vibration of the movable magnet is most activated in the case in which the movable magnet is supported by the single elastic member in a cantilever type as described above.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A device for generating micro electrical current comprising:
a housing having an accommodation space therein;
a coil block accommodated inside the housing;
a movable magnet movably provided at one surface of the coil block to generate a micro electrical current through interaction with the coil block; and
an elastic member for elastically supporting movement of the movable magnet with respect to the coil block,
wherein after a first motion of the movable magnet with respect to the coil block, the movable magnet vibrates by the elastic member and interacts with the coil block.

2. The device for generating micro electrical current according to claim 1, wherein the elastic member includes:
a fixing portion fixed to the housing;
a bent elastic portion extending integrally from an end of the fixing portion; and
a support portion extending integrally from an end of the bent elastic portion and supporting the movable magnet,
wherein the movable magnet is elastically supported by the elastic member which works as a cantilever.

3. The device for generating micro electrical current according to claim 2, wherein the elastic member is a plate spring having long sides in cross section which are arranged vertically to the one surface of the coil block.

4. The device for generating micro electrical current according to claim 2, wherein the bent elastic portion is bent in a zigzag shape.

5. The device for generating micro electrical current according to claim 2, wherein the support portion is configured to elastically surround an outer surface of the movable magnet.

6. The device for generating micro electrical current according to claim 1, further comprising:
a stimulation member which is electrically connected to the coil block and arranged to contact a human body.

7. The device for generating micro electrical current according to claim 1, further comprising:
a coupling member configured to be coupled to an object,
wherein the housing is accommodated inside the coupling member.

8. The device for generating micro electrical current according to claim 1, wherein the housing includes an upper housing and a lower housing which cooperatively define the accommodation space thereinside, and the coil block is accommodated inside the lower housing, and the elastic member is coupled to the upper housing.

9. The device for generating micro electrical current according to claim 1, wherein the device generates a micro electrical current ranging from about 10 to about 1000 μA by interaction due to movement of the movable magnet with respect to the coil block.
